(19) United States
(12) Patent Application Publication
(10) Pub. No.: US 2025/0092167 A1
(43) Pub. Date: Mar. 20, 2025

(54) Process for reducing the VOC content of a polyolefin composition

(71) Applicant: Borealis AG, Vienna (AT)

(72) Inventors: Jingbo Wang, Linz (AT); Markus Gahleitner, Linz (AT); Klaus Bernreitner, Linz (AT); Pauli Leskinen, Porvoo (FI); Elisabeth Potter, Linz (AT)

(21) Appl. No.: 18/577,242

(22) PCT Filed: Jul. 13, 2022
(86) PCT No.: PCT/EP2022/069569

§ 371 Date: Jan. 6, 2024

(30) Foreign Application Priority Data
Jul. 30, 2021 (EP) 21188830.0

(51) Int. Cl. C08F 6/28

(52) U.S. Cl. CPC C08F 6/28; C08F 2500/24

(57) ABSTRACT

The present invention relates to a process for reducing the volatile organic compound (VOC, VDA 278 October 2011) content of a polyolefin composition, the polyolefin composition including a polypropylene homopolymer, a polypropylene copolymer, a polyethylene homopolymer, and/or a polyethylene copolymer, the process comprising the steps of a) subjecting the polyolefin composition having a VOC (VOC, VDA 278 October 2011) content, which is contained in an aeration vessel, to an aeration gas flow, and maintaining said aeration gas flow for an aeration time of 15 hours or less the aeration gas having a minimum temperature of at least 20° C. measured at an inlet of the aeration gas of the aeration vessel, and a maximum temperature of 99° C. measured at an inlet for aeration gas of the aeration vessel; the aeration vessel having—at least one inlet for aeration gas,—at least one outlet for aeration gas,—an inlet for the polyolefin composition having a VOC content,—an outlet for an aerated polyolefin composition at the bottom of the aeration vessel; wherein the polyolefin composition contains 20 to 55 pieces/g (pellet size 3-5 mm) as measured according to the specification; and wherein the polyolefin composition is present in the aeration vessel as a packed bed; and b) withdrawing the aerated polyolefin composition from the aeration vessel having a VOC content (VOC, VDA 278 October 2011) of not greater than 600 μg/g.

The present invention relates to a process for reducing the volatile organic compound (VOC, VDA 278 October 2011) content of a polyolefin composition, a polyolefin composition having a VOC content (VOC, VDA 278 October 2011) of not greater than 600 μg/g obtainable by the process of the invention and an article comprising the polyolefin composition having a VOC content (VOC, VDA 278 October 2011) of not greater than 600 μg/g obtainable by the process of the invention.

Polyolefin polymers often contain traces of substances applied or generated during the polymerization process. These substances can for example be traces of the medium in which the reaction has been carried out, but can also be residual monomers and oligomers. These substances can lead to hydrocarbon emissions of the polyolefins. Various options for removing these volatiles are known involving the use of solvents such as water, the use of vapor as well as hot gaseous streams.

A process for preparing a polyolefin polymer comprising the steps of forming a particulate polyolefin polymer by polymerizing one or more olefins in the presence of a polymerization catalyst system in a polymerization reactor, discharging the formed polyolefin particles from the polymerization reactor; degassing the polyolefin particles by a process comprising at least a final step of contacting the particles with a nitrogen stream in a degassing vessel, and transferring the particles from the vessel, in which the contacting of the particles with the nitrogen stream is carried out, to a melt mixing device, which the polyolefin particles are melted, mixed and thereafter pelletized is disclosed in WO 2014090856 A1.

EP 3126408 B1 discloses a method for the manufacture of polypropylene having a melt flow rate of from 10 to 200 g/10 min comprising the subsequent steps of (i) polymerizing propylene monomer, and optionally one or more alpha olefin co-monomers so as to form a polypropylene having an initial MFR of from 0.5 to 20 g/10 min (ISO 1133, 230° C., 2.16 kg), (ii) visbreaking said polypropylene of step i) to obtain polypropylene having said target MFR and wherein the ratio of target to initial MFR is more than 1, and (iii) maintaining the polypropylene obtained from step ii) at a temperature of at least 105° C. for a period of at least 48 hr. The product is defined by an FOG value as measured in accordance with VDA 278 of the polypropylene obtained after step (iii) of at most 600 μg/g.

In EP 18203757 a process applying aeration for reducing the volatile and semi-volatile organic compounds of a polypropylene composition to below 150 μg/g (VOC, VDA 278 October 2011) and below 350 μg/g (FOG, VDA 278 October 2011) is discussed, whereby the polypropylene composition includes a polypropylene homopolymer and/or a polypropylene random copolymer.

Common to all these disclosures is the need to apply a process at rather high temperatures and/or for long periods of time.

Polyolefins regularly contain certain amounts of volatile organic compounds which are not desirable with respect to safety, applications the polyolefin compositions are used for and/or with respect to unpleasant odor effects. Also health issues for consumers and animals can play a role. An example for a source of VOCs is the use of olefins like ethylene, propylene, butene, hexene, or octene, which are widely used as monomers and comonomers in polyolefin production. The left-over monomers can create problems in safety for example when it comes to storage and transport of the polyolefin composition and/or odor in finished products being produced from the respective compositions. Hence, removal of the volatiles from the final product is essential for quality of the products.

Therefore, there is an interest to develop acceptable processes, which lead to a reduction in VOC.

Aeration processes are particularly desirable as they are post polymerization processes, which can be used to treat a range of polymers following polymerization. However, the known volatile reduction methods still have shortfalls. High aeration temperatures have the effect that the aerated material is oxidized leading to degradation of the polymeric material as well as disadvantageous coloring such as yellowing.

The present invention is based on the finding, that desirable low amounts of volatiles can be obtained by subjecting polyolefin compositions including a polypropylene homopolymer, a polypropylene copolymer, a polyethylene homopolymer, and/or a polyethylene copolymer to an aeration step being characterized by subjecting the polyolefin composition to an aeration gas flow, relatively low aeration temperatures and relatively short aeration time.

The aeration process of the present invention leads to polyolefin compositions which contain an advantageously low amount of VOCs. Another advantage is that the structural integrity of the polymeric material is not affected as the polyolefins are not oxidized by the aeration process. Another advantage is that the aerated polymers have an almost unchanged melt flow rate and also show an improved Yellowness Index.

### SUMMARY OF THE INVENTION

The present invention is based on the finding that the volatile organic compound (VOC, VDA 278 October 2011) content of a polyolefin composition including a polypropylene homopolymer, a polypropylene copolymer, a polyethylene homopolymer, and/or a polyethylene copolymer can be significantly reduced by subjecting the polyolefin composition having a VOC (VOC, VDA 278 October 2011) content to an aeration gas flow, and maintaining said aeration gas flow for an aeration time of 15 hours or less, the aeration gas having a minimum temperature of at least 20° C. measured at an inlet of the aeration gas of the aeration vessel, and a maximum temperature of 99° C. measured at an inlet for aeration gas of the aeration vessel and wherein the polyolefin composition is present in the aeration vessel as a packed bed, and wherein the polyolefin composition contains 20 to 55 pieces/g (pellet size 3-5 mm) as measured according to the specification; and withdrawing the aerated polyolefin composition from the aeration vessel having a VOC content (VOC, VDA 278 October 2011) of not greater than 600 μg/g.

The present invention insofar provides a process for reducing the volatile organic compound (VOC, VDA 278 October 2011) content of a polyolefin composition,
the polyolefin composition including a polypropylene homopolymer, a polypropylene copolymer, a polyethylene homopolymer, and/or a polyethylene copolymer,
the process comprising, preferably consisting of, the steps of
   a) subjecting the polyolefin composition having a VOC (VOC, VDA 278 October 2011) content, which is contained in an aeration vessel, to an aeration gas flow, and maintaining said aeration gas flow for an aeration time of 15 hours or less, preferably from 1 to 15 hours, the aeration gas having a minimum temperature of at least 20° C. measured at an inlet of the aeration gas of the aeration vessel, and a maximum temperature of 99° C. measured at an inlet for aeration gas of the aeration vessel;
      the aeration vessel having
         at least one inlet for aeration gas,
         at least one outlet for aeration gas,
         an inlet for the polyolefin composition having a VOC content, preferably at the top of the aeration vessel,
         an outlet for an aerated polyolefin composition at the bottom of the aeration vessel;
   wherein the polyolefin composition contains 20 to 55 pieces/g (pellet size 3-5 mm) as measured according to the specification, preferably 25 to 50 pieces/g (pellet size 3-5 mm) and more preferably 30 to 45 pieces/g (pellet size 3-5 mm);
   wherein the polyolefin composition is present in the aeration vessel as a packed bed; and
   b) withdrawing the aerated polyolefin composition from the aeration vessel having a VOC content (VOC, VDA 278 October 2011) of not greater than 600 μg/g.

The present invention also provides a polyolefin composition having a VOC content (VOC, VDA 278 October 2011) of not greater than 600 μg/g, preferably in the range of 1 to 600 μg/g, obtainable by the process for reducing the volatile organic compound (VOC, VDA 278 October 2011) content of a polyolefin composition.

The present further provides an article comprising a polyolefin composition having a VOC content (VOC, VDA 278 October 2011) of not greater than 600 μg/g, preferably in the range of 1 to 600 μg/g, obtainable by the process for reducing the volatile organic compound (VOC, VDA 278 October 2011) content of a polyolefin composition.

### Definitions

The term “volatile organic compound content” or “VOC content” refers to the toluene equivalent content in a sample emission of material determined according to the ‘Verband der Automobilindustrie’ recommendation VDA 278 October 2011. Volatile organic compound content is a measure of emissions from plastic materials, which are caused by low-molecular components in the polymer material, generally alkanes with carbon chain length of up to C₂₀. These low-molecular components can be residual monomers, oligomers, additives, plasticizers and/or degradation products.

The term semi-volatile organic condensables content (FOG content) refers to the n-hexadecane equivalent content in a sample emission of material determined according to the ‘Verband der Automobilindustrie’ recommendation VDA 278 October 2011. Semi-volatile organic compound content is a measure of emissions from plastic materials, which are caused by medium molecular weight components, such as oligomers, which have a boiling point in the range of C₁₄-C₃₂ alkanes.

The term composition may refer to both homopolymers and copolymers, which may optionally contain further components and/or additives.

The term gas flow such as used herein denotes the volume of gas flowing per hour.

The term gas such as used herein denotes any gas suitable for being heated up to at least 20° C. and suitable for removing volatile organic compounds from polyolefin compositions. Suitable gases are for example nitrogen or air or mixtures thereof. In principle any inert gas may be used. Simply for cost reasons, the most preferred gas for the process of the invention is air.

The gas, which leaves the packed bed of the polyolefin composition, i.e. which took up the volatile organic compounds, is denoted as exhaust gas herein.

The term granular such as used herein denotes a polyolefin composition in the form of pellets and/or granulated material. Usually the pellets or granulated material will result from pelletizing or granulation. For example, pellets can be formed by forcing the polyolefin composition melt through a die and pelletizing it subsequently with an underwater granulator.

The term aeration or aeration process as used herein denotes a process or process step, in which a compound is subjected to a gas flow.

The term pressure of the aeration such as used herein is the pressure which is present inside the aeration vessel. When a silo is used as the most conventional aeration vessel, the pressure is to be easily measured at the free headspace, in particular at the freeboard or at the gas outlet duct on top of the silo.

A batch-wise aeration process is a process, in which polyolefin compositions to be aerated are fed to aeration vessels, whereby the whole of each batch is subjected to one stage of the aeration process at a time and the aerated polyolefin composition is removed from the aeration vessel all at once after the process has finished. In contrast to a continuous process, a batch-wise process cannot be carried out for an arbitrary amount of time, as the state of the material (e.g. the content of volatiles) in the aeration vessel defines the time when the process has to be interrupted, e.g. for removing the aerated polyolefin composition and refilling with polyolefin composition to be aerated.

The term preheating step denotes a step generally preceding the aeration step, in which the polyolefin compositions are heated up to the desired temperature for aeration. Preheating the polyolefin composition can facilitate the aeration process and reduce the time needed for the overall process. Furthermore, certain means of preheating can reduce the power consumption of the aeration process.

The aeration time is the time period between the start and the end of a gas stream and the resulting gas flow in the aeration vessel. Thus, as soon as the gas stream is started and adjusted and the gas flow proceeds through the aeration vessel, the aeration time is running. Respectively, as soon as the gas stream is stopped, i.e. when the desired target VOC content is reached, the aeration time ends. If the polyolefin composition is preheated by external means, e.g. without gas flow, the aeration time also starts with the start of the gas stream after the preheating step. If the polyolefin composition is preheated with the help of a gas flow, the aeration time already starts with the start of the gas flow of the preheating step and ends with the stop of the gas flow after the actual aeration step, i.e. when the desired target VOC content is reached.

Throughout the present application, the particle size is described by its particle size distribution. The value d, represents the diameter relative to which x % by weight of the particles have diameters less than dx. The d₅₀ value is thus the “median particle size” at which 50 wt. % of all particles are smaller than the indicated particle size. The d₉₀ value is the value where 90 wt. % of all particles have a diameter less than the d₉₀.

### DETAILED DESCRIPTION

It has been surprisingly found that the reduction rates of VOC obtained by the inventive process are excellent for the given energy effort and aeration time. Further the inventive process can be used in commercial scale to homogeneously reduce VOC to acceptable levels at relatively low effort. Besides, there is no need for time consuming aeration of polyolefin compositions. In addition to that, the inventive process does not affect the integrity of the polymeric material and oxidation is avoided.

In the process according to the present invention the polyolefin composition including a polypropylene homopolymer, a polypropylene copolymer, a polyethylene homopolymer, and/or a polyethylene copolymer is subjected to a gas flow in an aeration vessel. In the simplest form the aeration vessel can be any vessel or pipe allowing settling of the polyolefin composition and injection of gas having at least one inlet for aeration gas, at least one outlet for aeration gas, an inlet for the polyolefin composition having a VOC content, preferably at the top of the aeration vessel, and an outlet for an aerated polyolefin composition at the bottom of the aeration vessel.

In the process according to the present invention the polyolefin composition is present in the aeration vessel as a packed bed.

In the process of the present invention the aeration gas flow is maintained for an aeration time of 15 hours or less, preferably from 1 to 15 hours.

In the process of the present invention the aeration gas has a minimum temperature of at least 20° C. measured at an inlet of the aeration gas of the aeration vessel, and a maximum temperature of 99° C. measured at an inlet for aeration gas of the aeration vessel.

In the process of the present invention an aerated polyolefin composition having a VOC content (VOC, VDA 278 October 2011) of not greater than 600 μg/g is withdrawn from the aeration vessel.

Insofar, the invention relates to a process for reducing the volatile organic compound (VOC, VDA 278 October 2011) content of polyolefin compositions including a polypropylene homopolymer, a polypropylene copolymer, a polyethylene homopolymer, and/or a polyethylene copolymer,
the process comprising, preferably consisting of, the steps of
a) subjecting the polyolefin composition containing VOCs (VOC, VDA 278 October 2011), which is contained in an aeration vessel, to an aeration gas flow, and maintaining said aeration gas flow for an aeration time of 15 hours or less, preferably from 1 to 15 hours, the aeration gas having a minimum temperature of at least 20° C. measured at an inlet of the aeration gas of the aeration vessel, and a maximum temperature of 99° C. measured at an inlet for aeration gas of the aeration vessel;
   the aeration vessel having
      at least one inlet for aeration gas,
      at least one outlet for aeration gas,
      an inlet for the polyolefin composition having a VOC content, preferably at the top of the aeration vessel,
      an outlet for an aerated polyolefin composition at the bottom of the aeration vessel;
   wherein the polyolefin composition contains 20 to 55 pieces/g (pellet size 3-5 mm) as measured according to the specification,, preferably 25 to 50 pieces/g (pellet size 3-5 mm) and more preferably 30 to 45 pieces/g (pellet size 3-5 mm);
   wherein the polyolefin composition is present in the aeration vessel as a packed bed; and
b) withdrawing the aerated polyolefin composition from the aeration vessel having a VOC content (VOC, VDA 278 October 2011) of not greater than 600 μg/g.

In a preferred embodiment the aerated polyolefin composition withdrawn in step b) has a lower or equal Yellowness Index (YI), as measured according to ASTM E 313 on pellets, than the polyolefin composition before subjecting it to the aeration gas flow in step a); and/or the aerated polyolefin composition withdrawn in step b) has a Yellowness Index (YI) of equal or lower than 1, preferably in the range of −20 to 1 and more preferably in the range of −15 to 1.

These surprisingly good YI values demonstrate that the polyolefin composition is not oxidized during the aeration process. This is in contrast to the expected finding according to which aeration influences the structural integrity of the aerated polymeric material negatively. In addition to that, it is also a proof that VOC are removed which usually influence the YI negatively.

It is even further preferred that the aerated polyolefin composition withdrawn in step b) has a VOC content (VOC, VDA 278 October 2011) in the range of 1 to 600 μg/g, preferably in the range of 5 to 550 μg/g, and more preferably in the range of 10 to 500 μg/g.

In certain embodiments, the inventive process leads to a reduction of VOC values (VOC, VDA 278 October 2011) of the polyolefin composition of greater than 20%, preferably greater than 40% and more preferably of greater than 60%.

In accordance with another embodiment the polyolefin composition includes a polypropylene copolymer and/or a polyethylene copolymer, preferably a copolymer of propylene or ethylene, and butene, pentene, hexene, heptene and/or octene, and more preferably a copolymer of propylene or ethylene, and butene, hexene and/or octene.

If not mentioned otherwise butene, pentene, hexene, heptene and octene refers to 1-butene, 1-pentene, 1-hexene, 1-heptene and 1-octene.

According to another preferred embodiment, the aerated polyolefin composition withdrawn in step b) has a combined residual C₂/C₃ content in the range of 0.1 to 100 wt. %-ppm, preferably of 1 to 60 wt. %-ppm; and/or a combined residual C₄-C₈ content in the range of 0 to 1200 wt. %-ppm, preferably of 10 to 1000 wt. %-ppm, and more preferably a C₆ content as determined according to the specification in the range of 0 to 1200 wt. %-ppm.

In certain embodiments the aerated polyolefin composition withdrawn in step b) has a combined residual C₂/C₃ content in the range of 0.1 to 100 wt. %-ppm, preferably of 1 to 60 wt. %-ppm, a combined residual C₄-C₈ content in the range of 0 to 1200 wt. %-ppm and a YI of −20 to 1.

In a preferred embodiment the polyolefin composition is a polypropylene composition including a polypropylene homopolymer and/or polypropylene copolymer, preferably a polypropylene copolymer, more preferably a copolymer of propylene and butene, pentene, hexene, heptene and/or octene, and most preferably a copolymer of propylene and butene, hexene and/or octene.

It is further preferred that the aerated polyolefin composition withdrawn in step b) has a residual C₃ content as determined according to the specification in the range of 0.1 to 100 wt. %-ppm, preferably of 1 to 60 wt. %-ppm.

Even further preferred the aerated polyolefin composition withdrawn in step b) has a residual C₆ content as determined according to the specification in the range of 1 to 1200 wt. %-ppm, preferably of 50 to 900 wt. %-ppm.

In the process according to the present invention the polyolefin composition in step a) is in granular form preferably having a particle size (d₉₀) in the range of 1.0 mm to 7.0 mm, preferably 1.5 mm to 6.5 mm, more preferably in the range of 1.5 mm to 6.0 mm, and even more preferably of 2.0 mm to 5.0 mm.

In the process according to the present invention the polyolefin composition in step a) is in granular form preferably having a particle size (d₅₀) in the range of 0.5 mm to 6.0 mm, preferably 1.0 mm to 5.5 mm, more preferably in the range of 1.5 mm to 5.0 mm, and even more preferably of 2.0 mm to 4.5 mm. In the process according to the present invention the ratio of aeration gas to polyolefin composition in step a) is in the range of 0.5:10, preferably in the range of 1:7 and more preferably in the range of 1:5.

The ratio of aeration gas to polyolefin composition is calculated according to the following formula (I):

$$\frac{aeration gas flow ( kg / h ) * aeration time ( h )}{amount of polyolefin composition aerated ( kg )} \qquad ( I )$$

The aeration time depends on the starting material and the target VOC content as well as the aeration conditions. According to a preferred embodiment the aeration time in step a) is 13 hours or less, preferably 11 hours or less, and more preferably 9 hours or less. It is preferred that the aeration time in step a) is at least 1 hour, and preferably at least 2 hours.

In the process according to the present invention the aeration gas in step a) preferably has a temperature in the range of 25 to 95° C., more preferably of 30 to 90° C. and even more preferably of 40 to 90° C. measured at an inlet of the aeration gas of the aeration vessel.

As the specific heat capacity of the polyolefin composition together with the mass of the polyolefin composition is significant compared to the specific heat capacity of gas together with the mass of the gas, one has to be attentive that the gas flow temperatures are met for the inlet and the outlet of the aeration. Thus, if the polyolefin composition is provided at relatively low temperature in a silo, a preheating will be necessary. The preheating naturally can also be effected by the gas flow, and the temperatures as specified above. However, during such preheating the temperature at the outlet will be lower, as the heat is transferred to the polyolefin composition.

For shortening the preheating phase, avoiding energy loss during aeration and/or also increased homogeneity over the cross-section, the use of an insulated aeration vessel, preferentially an insulated silo is preferred.

Thus, the polyolefin composition is preferably preheated before the start of the aeration time to speed up the process. Generally, any heating measures known in the prior art can be used for preheating. Either the polyolefin composition or the aeration vessel, i.e. the silo, or both together can be preheated.

The polyolefin composition, the aeration vessel or both together can be preheated externally. Under the term externally preheating such as used herein it is understood that the preheating is carried out by external preheating means. External preheating means can be solar collectors, heating by electricity or heating by any kind of radiation. Preheating the aeration vessel externally happens by heating up the walls of the vessel. External heating the walls of the vessel can happen by general means for heating a vessel, e.g. by electricity or, but also simply by sunshine directly on the outer wall of the vessel. The aeration vessel and the polyolefin composition can also be separately preheated by external preheating means and after preheating the preheated polyolefin composition is provided in the preheated aeration vessel.

Preheating could also be considered as not letting the polyolefin composition cool down, which is produced, extruded and pelletized shortly beforehand. Hence, the production process of the polyolefin composition and the process of the current invention can be carried out in an integrated process.

Preheating can also be carried out by starting the process at a higher gas flow and reducing the gas flow to the target gas flow when the temperature at the top of the silo is close to the temperature at the bottom of the silo. Preheating must also meet the conditions of the temperature of the gas flow such as defined for the gas flow above.

Preferably, the polyolefin composition, the aeration vessel or both together are preheated externally.

According to a particularly preferred embodiment, the present invention provides a process for reducing the volatile organic compound (VOC, VDA 278 October 2011) content of polyolefin compositions including a polypropylene homopolymer and/or a polypropylene copolymer
the process comprising, preferably consisting of, the steps of
a) subjecting the polyolefin composition containing VOCs (VOC, VDA 278 October 2011), which is contained in an aeration vessel, to an aeration gas flow, and maintaining said aeration gas flow for an aeration time of 13 hours or less, preferably from 2 to 13 hours, the aeration gas having a minimum temperature of at least 20° C. measured at an inlet of the aeration gas of the aeration vessel, and a maximum temperature of 95° C. measured at an inlet for aeration gas of the aeration vessel;
   the aeration vessel having
      at least one inlet for aeration gas,
      at least one outlet for aeration gas,
      an inlet for the polyolefin composition having a VOC content, preferably at the top of the aeration vessel,
      an outlet for an aerated polyolefin composition at the bottom of the aeration vessel;
   wherein the polyolefin composition contains 20 to 55 pieces/g (pellet size 3-5 mm) as measured according to the specification; and
   wherein the polyolefin composition is present in the aeration vessel as a packed bed; and
b) withdrawing the aerated polyolefin composition from the aeration vessel having a VOC content (VOC, VDA 278 October 2011) of not greater than 600 μg/g.

In the process according to the present invention the polyolefin composition before subjecting it to the aeration gas flow in step a) has an MFR₂ of 25 g/10 min or lower (ISO 1133 at 2.16 kg load and 230° C.), preferably an MFR₂ in the range of 1.0 to 20 g/10 min, and more preferably an MFR₂ in the range of 2.0 to 15 g/10 min.

In the process according to the present invention process wherein the aerated polyolefin composition withdrawn in step b) has an MFR₂ of 20 g/10 min or lower (ISO 1133 at 2.16 kg load and 230° C.), preferably an MFR₂ in the range of 0.5 to 20 g/10 min, and more preferably an MFR₂ in the range of 2.0 to 15 g/10 min.

In the process according to the present invention the process is used in a continuous polymerization process.

In the process according to the present invention the polyolefin composition subjected to step a) originates from continuous heterogeneous polymerization process.

In the process according to the present invention the aeration vessel comprises a silo comprising a main vertical cylinder and a conical section at the bottom of the cylinder.

According to a preferred embodiment of the invention the aeration gas used in step a) is an N₂ containing gas, preferably air.

In the process according to the present invention the aeration gas in step a) is injected from the bottom of the aeration vessel. Preferably, the gas is injected via a gas distribution ring located on the bottom cone of a silo, resulting in a gas flow from bottom to top through the bed of pellets.

In a further embodiment of the invention, more than one distribution ring can be provided in the aeration vessel, e.g. sequentially located along the flow pathway of the gas in the bed of polyolefin composition and/or with different radii ensuring that the gas distribution in the bed of polyolefin composition is homogeneous. Preferably, the gas is introduced through nozzles provided in the distribution ring. More preferably, the gas is introduced to at least two nozzles per distribution ring.

In a further embodiment of the invention, the height/diameter ratio of the bed formed by the polyolefin composition used for the process of the present invention is preferably at least 1, more preferably at least 3. Moreover, the height/diameter ratio of the bed formed by the polyolefin composition of the present invention does preferably not exceed 6, more preferably does not exceed 5.

The process according to the present invention is preferably run batch-wise.

In the process of the present invention step a) and step b) preferably are performed sequentially.

In the process according to the present invention the polyolefin composition is preferably not mixed or moved throughout the aeration by mechanical means. Absence of mechanical mixing or the like is particularly advantageous since the creation of fines is avoided.

The process according to the present invention is particularly advantageous for polyolefin compositions obtained by continuous heterogeneous polymerization. This is in particular due to the fact that the polyolefin composition such as obtained from the production process (i.e. solution polymerization reactor, degassing unit(s) and extruder(s)) usually contains relatively high amounts of VOC. Hence, the volatile organic compound content is usually too high for demanding end-use applications and storage as well as transportation would cause safety risks.

The total process of producing the polyolefin composition and the aeration insofar is an integrated process.

The process according to the present invention comprises a step of preferably subjecting the gas downstream of the aeration vessel to means for removing hydrocarbons. Preferably, these means are selected from one or more catalytic oxidation units, one or more carbon adsorption columns (drums) and/or any conventional exhaust treatment known in the art. Even more preferably, these means are carbon adsorption columns (drums). Preferably, when the aeration gas is air and/or nitrogen, it can be emitted into the atmosphere after removal of the hydrocarbons.

Moreover, the heat still contained in the discharged gas can be transferred to the gas used for aeration via heat exchangers known in the art, if the gas taken from the environment has a temperature lower than the temperature needed for the process. In another embodiment of the invention, a chiller is used, if the gas taken from the environment has a temperature higher after compression than the temperature needed for the process. Preferably, in such a chiller, water is cooled down to ±10 to ±15° C. in a cooler and subsequently used in a heat exchanger to cool down the gas from ±40° C. to ±30° C.

In the process according to the present invention the exhaust gas is preferably discharged into the atmosphere. Alternatively but less preferably the exhaust gas is used again after separation of the VOCs.

The present invention is also concerned with an integrated process for producing a polyolefin composition, the process comprising, preferably consisting of, the steps of
a) polymerizing ethylene or propylene, optionally copolymerizing with a C₄ to C₈ comonomer by continuous heterogeneous polymerization in at least one polymerization reactor to yield a raw polymerization mixture,
b) recovering said raw polymerization mixture from the at least one polymerization reactor and feeding said raw polymerization mixture to at least one flash vessel thereby at least partially removing solvent, unreacted monomer and optionally unreacted comonomer to yield a raw polyolefin composition,
c) subjecting the polyolefin composition to mixing, preferably by an extruder or a static mixer, and granulation,
d) recovering the polyolefin composition,
e) subjecting the polyolefin composition having a VOC (VOC, VDA 278 October 2011) content, which is contained in an aeration vessel, to an aeration gas flow, and maintaining said aeration gas flow for an aeration time of 15 hours or less, preferably from 1 to 15 hours, the aeration gas having a minimum temperature of at least 20° C. measured at an inlet of the aeration gas of the aeration vessel, and a maximum temperature of 99° C. measured at an inlet for aeration gas of the aeration vessel;
   the aeration vessel having
      at least one inlet for aeration gas,
      at least one outlet for aeration gas,
      an inlet for the polyolefin composition having a VOC content, preferably at the top of the aeration vessel,
      an outlet for an aerated polyolefin composition at the bottom of the aeration vessel;
   wherein the polyolefin composition contains 20 to 55 pieces/g (pellet size 3-5 mm) as measured according to the specification, preferably 25 to 50 pieces/g (pellet size 3-5 mm) and more preferably 30 to 45 pieces/g (pellet size 3-5 mm); and
   wherein the polyolefin composition is present in the aeration vessel as a packed bed;
   and
f) withdrawing the aerated polyolefin composition from the aeration vessel having a VOC content (VOC, VDA 278 October 2011) of not greater than 600 μg/g.

All preferred ranges and embodiments as described above also hold for this integrated process and are incorporated by reference herewith.

It is particularly preferred that the polyolefin composition is sent directly to the aeration vessel.

In the processes of the present invention, i.e. the aeration process and the integrated process as described above, the lower aeration time is not specifically limited. Usually the aeration will be carried out until the volatile organic compound content of the polyolefin composition will be below 700 μg/g.

The processes of the present invention, i.e. the aeration process and the integrated process as described above are particularly advantageous within and for the production of the polyolefin compositions having a MFR₂ of 20 g/10 min or lower (ISO 1133 at 2.16 kg load and 230° C.). The softer polyolefin compositions profit from the mild process conditions of the inventive processes. Oxidation is avoided. The advantageous nature is even more pronounced for polyolefin composition having a MFR₂ of 15 g/10 min or lower (ISO 1133 at 2.16 kg load and 230° C.).

An aspect of the invention relates to a polyolefin composition having a VOC content (VOC, VDA 278 October 2011) of not greater than 600 μg/g, preferably the range of 1 to 600 μg/g, obtainable by the inventive process.

According to a preferred embodiment the polyolefin composition includes a polypropylene homopolymer and/or copolymer, preferably a polypropylene copolymer.

All preferred ranges and embodiments as described above also hold for this polyolefin composition and the process and are incorporated by reference herewith.

Another aspect of the present invention relates to an article comprising the polyolefin composition having a VOC content (VOC, VDA 278 October 2011) of not greater than 600 μg/g, preferably in the range of 1 to 600 μg/g, obtainable by the inventive process.

According to a preferred embodiment the polyolefin composition includes a polypropylene homopolymer and/or copolymer, preferably a polypropylene copolymer.

All preferred ranges and embodiments as described above also hold for this polyolefin composition and the process and are incorporated by reference herewith.

Preferably the article is a film or a packaging material.

### Experimental Part

The following Examples are included to demonstrate certain aspects and embodiments of the invention as described in the claims. It should be appreciated by those of skill in the art, however, that the following description is illustrative only and should not be taken in any way as a restriction of the invention.

### Test Methods

### VOC and FOG According to VDA278

For the thermodesorption analysis according to VDA 278 (October 2011) the samples were stored uncovered at room temperature (23° C. max.) for 7 days directly before the commencement of the analysis.

VOC value is determined according to VDA 278 October 2011 from pellets. VDA 278 October 2011, Thermal Desorption Analysis of Organic Emissions for the Characterization of Non-Metallic Materials for Automobiles, VDA (Verband der Automobilindustrie). According to the VDA 278 October 2011 the VOC value is defined as “the total of the readily volatile to medium volatile substances. It is calculated as toluene equivalent. The method described in this Recommendation allows substances in the boiling/elution range up to n-Pentacosane (C25) to be determined and analyzed.”

FOG value is determined according to VDA 278 October 2011 from pellets, too. According to the VDA 278 October 2011 the FOG value is defined as “the total of substances with low volatility which elute from the retention time of n-Tetradecane (inclusive). It is calculated as hexadecane equivalent. Substances in the boiling range of n-Alkanes “C14” to “C32” are determined and analyzed.”

### Melt Flow Rate (MFR₂)

The melt flow rates were measured with a load of 2.16 kg (MFR₂) at 230° C. The melt flow rate is the quantity of polymer in grams which the test apparatus standardized to ISO 1133 extrudes within 10 minutes at a temperature of 230° C. under a load of 2.16 kg.

### Yellowness Index (YI)

Yellowness Index was determined according to ASTM E 313 on pellets.

### Residual Monomer Content in Pellets

The residual of ethylene (C₂), propylene (C₃), butene (C₄), pentene (C₅), hexene (C₆), heptene (C₇) and octene (C₈), that is, C₂-C₈, in pellets were detected with static headspace gas chromatography. Agilent 6890 equipped with a flame ionization detector (FID) is used as Gas chromatograph.

Details as following:
Temperature: 200° C.
Septum purge: 2 ml/min
Total flow: 30 ml/min
Detector Type: FID, Temperature 250° C.
Flows, carrier gas: Helium 3 ml/min
Column Type: 25 m×0.32 mm×2.5 μm
Filling: SE-30
Condition for column: max temperature 250° C.
Sample feeder: Agilent G1888 Headspace sample feeder
Oven 120° C.
Transferline 130° C.
Loop 125° C.
GC cycle time 40.0 min
Vial EQ time 60.0 min
Pressurizing time 0.05 min
Loop fill time 0.15 min
Loop EQ time 0.05 min
Inject time 0.40 min
Carrier helium 0.81 bar

For each measurement 2000±20 mg samples are used.

The information system automatically calculates the analysis of the gas chromatograph with the parameters according to the calculation data if it finds peaks at the correct time intervals. The volatile compounds in the sample (mg/kg) are calculated by the formula: mg/kg=(sum of sample peak areas×Rf)/(Sample weight (mg))×1 000 000, Rf=factor (n-octane).

### Determination of Particle Size (d₉₀) and Pieces of Polyolefin Composition Particles per Gram

The measurement of contamination, as well as size and form of the polyolefin composition particles is performed with the pellet analysis system PA66 (supplied by OCS Optical Control Systems GmbH, Germany), having two independent measurement units, the pellet contamination analysis system (PS25C), and the particle shape and size distribution (PSSD) with two corresponding data processing systems.

PS25C is a CCD (charge-coupled device) high speed camera taking pictures of the single particles and classifying the particles according to the colour spectrum. The material is inspected with respect to contaminants, discoloration and foreign objects.

In the PSSD, the polyolefin composition particles are brought to a high-speed line sensor via a vibration table, which scans the particles two-dimensionally as they fall. The size is measured and the particles are classified.

1 litre of the sample to be measured is placed dry in the funnel of the PS25C. A sample that had to be dried in the polyolefin composition particle dryer cannot be used to determine the defects, as it is contaminated by the drying.

The polyolefin composition particles to be measured fall through the upper feed pipe of the PS25C onto the material chute of the vibration unit. The measuring chamber contains the material chute and the illumination unit, and on top of them the camera unit.

The camera takes photos of the objects, which differ from the color spectrum of the interior of the measuring chamber, the polyolefin particles and the material chute. Subsequently, the material falls through a hopper and another feed pipe onto the vibration plate of the PSSD. The chutes of the vibration plate ensure uniform distribution of the polyolefin particles on the plate and guide them in controlled paths to the edge. The high-speed line sensor takes two-dimensional images of the falling polyolefin particles in backlight. The data processing system measures, counts and characterizes the images and passes them on to the data processing system of the PS25C. A balance is located under the collection container.

The particle size distribution and the upper particle size limit (d₉₀) and (d₅₀) can be calculated from the results obtained from the PSSD. In addition to that, the pellet size and the amount of pieces of polyolefin composition particles per gram [pieces/g] are also determined from the PSSD measurement results.

The amount of pieces of the polyolefin composition per gram is given for a pellet size of 3-5 mm.

### Experiments

### Materials

The catalyst used is anti-dimethylsilanediyl[2-methyl-4,8-di(3,5-dimethylphenyl)-1,5,6,7-tetrahydro-s-indacen-1-yl][2-methyl-4-(3,5-dimethylphenyl)-5-methoxy-6-tert-butylinden-1-yl] zirconium dichloride as disclosed in WO 2020/239602 A1 as ICS3.

### Preparation of MAO-Silica Support

A steel reactor equipped with a mechanical stirrer and a filter net was flushed with nitrogen and the reactor temperature was set to 20° C. Next silica grade DM-L-303 from AGC Si-Tech Co, pre-calcined at 600° C. (5.0 kg) was added from a feeding drum followed by careful pressurizing and depressurizing with nitrogen using manual valves. Then toluene (22 kg) was added. The mixture was stirred for 15 min. Next 30 wt.-% solution of MAO in toluene (9.0 kg) from Lanxess was added via feed line on the top of the reactor within 70 min. The reaction mixture was then heated up to 90° C. and stirred at 90° C. for additional two hours. The slurry was allowed to settle and the mother liquor was filtered off. The catalyst was washed twice with toluene (22 kg) at 90° C., following by settling and filtration. The reactor was cooled off to 60° C. and the solid was washed with heptane (22.2 kg). Finally MAO treated SiO₂ was dried at 60° C. under nitrogen flow for 2 hours and then for 5 hours under vacuum (−0.5 barg) with stirring. MAO treated support was collected as a free-flowing white powder found to contain 12.2% Al by weight.

### Catalyst Preparation

30 wt.-% MAO in toluene (0.7 kg) was added into a steel nitrogen blanked reactor via a burette at 20° C. Toluene (5.4 kg) was then added under stirring. The catalyst as cited above (93 g) was added from a metal cylinder followed by flushing with 1 kg toluene. The mixture was stirred for 60 minutes at 20° C. Trityl tetrakis (pentafluorophenyl) borate (91 g) was then added from a metal cylinder followed by a flush with 1 kg of toluene. The mixture was stirred for 1 h at room temperature. The resulting solution was added to a stirred cake of MAO-silica support prepared as described above over 1 hour. The cake was allowed to stay for 12 hours, followed by drying under N₂ flow at 60° C. for 2 h and additionally for 5 h under vacuum (−0.5 barg) under stirring. Dried catalyst was sampled in the form of pink free flowing powder 25 containing 13.9% Al and 0.11% Zr.

The bimodal C₃C₆ copolymer was produced with the catalyst described above in a multistage polymerisation process according to the Borstar® technology. Table 1 shows the key polymerization data and particle sizes of the pellets.

The powder was compounded with 500 ppm of Irganox 1010 (BASF), 1000 ppm Irgafos 168 (BASF), 400 ppm DHT-4A (Kisuma Chemical), 1000 ppm Sylobloc 45 (GRACE) on a ZSK 57 twin screw extruder with melt temperature of 210° C. The pellets have MFR₂ of 6.7 g/10 min and Tm of 140° C.

TABLE 1
Polymerization and basic properties of polymer

| Prepolymerization | | |
|---|---|---|
| Temp. | ° C. | 20 |
| Residence time | min | 20 |
| Loop | | |
| Temp. | ° C. | 66 |
| Split | wt. % | 78 |
| H2/C3 | mol/kmol | 0.08 |
| C6/C3 | mol/kmol | 12.29 |
| MFR₂ | g/10 min | 6.2 |
| C6 after loop | wt. % | 2.3 |
| Gas phase reactor (GPR) | | |
| Temp. | ° C. | 72 |
| Split | wt. % | 22 |
| H2/C3 | mol/kmol | 0.9 |
| C6/C3 | mol/kmol | 15 |
| MFR₂ | g/10 min | 6.9 |
| C6 after GPR | wt. % | 3.5 |
| d₉₀ | mm | 4.6 |
| d₅₀ | mm | 3.6 |

### Aeration

The pellets were subjected to aeration at different temperatures/times in a lab scale aeration facility. For each treatment 25 kg pellets were used. The aeration pot was heated from ambient temperature to desired aeration temperature within 15 min, then kept at desired aeration temperature for certain time, then the pot was cooled down to ambient temperature within 1 h. The gas used in the process was dry N₂, in the preheating stage and the aeration stage the gas flow was 14 kg/h and the pressure was 3 bar, in the cooling stage the gas flow was 20 kg/h and 1.5 bar. The pellets were packed into aluminium bags to avoid further uncontrolled devolatization or contamination. The results are shown in table 2.

TABLE 2
Properties before (CE) and after aeration (IE1 to IE5)

| | | IE1 | IE2 | IE3 | IE4 | IE5 | CE1 |
|---|---|---|---|---|---|---|---|
| Aeration Temp. | ° C. | 23 | 45 | 60 | 60 | 85 | |
| Aeration time | h | 6 | 6 | 2 | 6 | 3 | |
| Ratio aeration | | 3.36 | 3.36 | 1.12 | 3.36 | 1.68 | |
| gas to PO comp. | | | | | | | |
| MFR₂ | g/10 min | 6.4 | 6.5 | 6.7 | 6.6 | 6.2 | 6.7 |
| VOC | μg/g | 540 | 476 | 397 | 396 | 156 | 629 |
| Fog | μg/g | 7 | 8 | 6 | 5 | 6 | 6 |
| YI | n.a. | 0.64 | 0.64 | 0.87 | 0.48 | 0.76 | 1.08 |
| C3 | wt. % ppm | 56 | 41 | 25 | 24 | 7.5 | 136 |
| C6 | wt. % ppm | 1169 | 1044 | 853 | 805 | 455 | 1280 |
| Pieces/g* | — | 40 | 40 | 40 | 40 | 40 | 40 |

*Pellet size between 3 and 5 mm for all Examples.

CE1 uses the pellets direct after production as described above. It has the highest VOC and C₃ as well as C₆ residuals.

As can be seen, the inventive examples show a reduction of VOC as well as a lower YI value. From the lower YI values can be derived that no oxidation appeared during aeration due to the mild aeration conditions. In addition to that, the MFR₂ was not affected by the aeration process further demonstrating that the integrity of the polymer was not affected by the aeration process.

Flushing the pellets at higher temperature helps to reduce the VOC content further, see for example IE1, IE2 and IE4.

1. A process for reducing the volatile organic compound (VOC, VDA 278 October 2011) content of a polyolefin composition,
the polyolefin composition including a polypropylene homopolymer, a polypropylene copolymer, a polyethylene homopolymer, and/or a polyethylene copolymer,
the process comprising the steps of
a) subjecting the polyolefin composition having a VOC (VOC, VDA 278 October 2011) content, which is contained in an aeration vessel, to an aeration gas flow, and maintaining said aeration gas flow for an aeration time of 15 hours or less, the aeration gas having a minimum temperature of at least 20° C. measured at an inlet of the aeration gas of the aeration vessel, and a maximum temperature of 99° C. measured at an inlet for aeration gas of the aeration vessel;
the aeration vessel having
at least one inlet for aeration gas,
at least one outlet for aeration gas,
an inlet for the polyolefin composition having a VOC content,
an outlet for an aerated polyolefin composition at the bottom of the aeration vessel;
wherein the polyolefin composition contains 20 to 55 pieces/g (pellet size 3-5 mm) as measured according to the specification; and
wherein the polyolefin composition is present in the aeration vessel as a packed bed; and
b) withdrawing the aerated polyolefin composition from the aeration vessel having a VOC content (VOC, VDA 278 October 2011) of not greater than 600 μg/g.

2. The process according to claim 1,
wherein the polyolefin composition is a polypropylene composition including a polypropylene homopolymer and/or polypropylene copolymer; and
wherein the aerated polyolefin composition withdrawn in step b) has a residual C₆ content as determined according to the specification in the range of 1 to 1200 wt. %-ppm.

3. The process according to claim 1,
wherein the polyolefin composition includes a polypropylene copolymer and/or a polyethylene copolymer.

4. The process according to claim 1,
wherein the aerated polyolefin composition withdrawn in step b) has a lower or equal Yellowness Index (YI), as measured according to ASTM E 313 on pellets, than the polyolefin composition before subjecting it to the aeration gas flow in step a); and/or
wherein the aerated polyolefin composition withdrawn in step b) has a Yellowness Index (YI) of equal or lower than 1.

5. The process according to claim 1,
wherein the polyolefin composition in step a) is in granular form having an particle size (d₉₀) in the range of 1.0 mm to 7.0 mm; and/or
wherein the polyolefin composition contains 25 to 50 pieces/g (pellet size 3-5 mm) as measured according to the specification.

6. The process according to claim 1,
wherein the aerated polyolefin composition withdrawn in step b) has a VOC content (VOC, VDA 278 October 2011) in the range of 1 to 600 μg/g; and/or
wherein the aerated polyolefin composition withdrawn in step b) has a combined residual C₂/C₃ content in the range of 0.1 to 100 wt. %-ppm; and/or
wherein the aerated polyolefin composition withdrawn in step b) has a combined residual C₄-C₈ content in the range of 0 to 1200 wt. %-ppm.

7. The process according to claim 1,
wherein the ratio of aeration gas to polyolefin composition, as determined according to formula (I), in step a) is in the range of 0.5:10.

8. The process according to claim 1,
wherein the aeration time in step a) is 13 hours or less; and/or
wherein the aeration time in step a) is at least 1 hour.

9. The process according to claim 1,
wherein the aeration gas in step a) has a temperature in the range of 25 to 95° C., measured at an inlet of the aeration gas of the aeration vessel.

10. The process according to claim 1,
wherein the polyolefin composition before subjecting it to the aeration gas flow in step a) has an MFR₂ of 25 g/10 min or lower (ISO 1133 at 2.16 kg load and 230° C.); and/or
wherein the aerated polyolefin composition withdrawn in step b) has an MFR₂ of 20 g/10 min or lower (ISO 1133 at 2.16 kg load and 230° C.).

11. The process according to claim 1,
wherein the process is used in a continuous polymerization process; and/or
wherein the polyolefin composition subjected to step a) originates from continuous heterogeneous polymerization process.

12. The process according to claim 1,
wherein the aeration vessel comprises a silo comprising a main vertical cylinder and a conical section at the bottom of the cylinder.

13. The process according to claim 1,
wherein the aeration gas used in step a) is N₂ containing gas; and/or
wherein the aeration gas in step a) is injected from the bottom of the aeration vessel.

14. Polyolefin composition having a VOC content (VOC, VDA 278 October 2011) of not greater than 600 μg/g, obtainable by the process according to claim 1.

15. Article comprising the polyolefin composition having a VOC content (VOC, VDA 278 October 2011) of not greater than 600 μg/g, obtainable by the process according to claim 1.
